(19) United States
(12) Patent Application Publication
(10) Pub. No.: US 2020/0023314 A1
(43) Pub. Date: Jan. 23, 2020

(54) A NOVEL EXHAUST AFTER-TREATMENT SYSTEM FOR A DIESEL ENGINE OR A SPARK IGNITION GASOLINE, CNG,LNG, ENGINE

(71) Applicant: Dan YITZHAKI, Haifa (IL)

(72) Inventor: Dan YITZHAKI, Haifa (IL)

(21) Appl. No.: 16/493,543

(22) PCT Filed: Mar. 20, 2018
(86) PCT No.: PCT/IL2018/000003

§ 371 Date: Sep. 12, 2019

(30) Foreign Application Priority Data
Mar. 23, 2017 (IL) 251356

(51) Int. Cl. B01D 53/94; F01N 3/20

(52) U.S. Cl. CPC B01D 53/9418; B01D 53/944; F01N 3/2066; F01N 3/206; B01D 2258/012; F01N 2610/04; F01N 2240/30; B01D 2251/202; F01N 3/2006

(57) ABSTRACT

Internal Combustion Engines, both Compression-Ignition (CI), mainly for Diesel oil, and Spark Ignition, for Gasoline, Compressed Natural Gas (CNG) or LPG emit pollutants during operation but particularly during cold startup in addition to nitrogen, carbon dioxide and water. The POLLUTANTS are: Carbon Monoxide (CO) Unburned Hydrocarbons (HC) and Nitrogen-Oxides (NOx) All cars today must be equipped with Catalytic Converters for oxidizing the CO to C02 and the HC to C02 and water and for the reduction of the NOx to N2 and water. These catalysts are inactive at temperatures below ca. 300 deg.c. and so when starting an engine from cold the emission of pollutants is high and not mitigated by the catalysts. Another problem is that a Reductant is required for the reduction of the NOx to N2 and water and the reductants in the exhaust gases namely CO and HC or Ammonia or Urea added to the flue gases are not efficient enough to fulfill the more stringent requirements for very low emission of NOx, There were many suggestions, in the literature and patents that propose the use of electrical heating of the catalysts monoliths, however the high burden on the batteries and also the long time needed for the heating made this approach virtually impractical. Another approach, for the DENOx and sometimes also for the cold startup was to manufacture hydrogen from water by electrolysis and first, store hydrogen and oxygen for injection into cold catalysts and ignite it prior to injection of the main fuel to the engine and secondly, during the run to produce hydrogen to be used as the reductant of NOx This approach also proved to be too difficult and costly and altogether impractical. In the present invention here an auxiliary small fuel system, preferably alcohol like Methanol, is installed. At cold startup the injection of the main fuel, such as Diesel Oil for CI engines or Gasoline for SI engines, is delayed for a few seconds and the compressed air from the engine flows into the after treatment main passage and mixes with injected Methanol and the mixture flows into the first catalyst section where at the inlet a metal net connected to an electrical source, such as a car battery, is heated igniting the mixture of air-methanol until the catalyst section is heated and then, in sequence, all catalyst sections, and in the case of a Diesel Engine also the DPF (DIESEL PARTICULATES FILTER), are heated up to the effective operating temperature. At that point all Methanol supply is cut off and a Methanol-Water mix is injected to a catalytic hydrogen production section (HPC) which is installed in parallel to the main exhaust passage and the Hydrogen rich stream is injected as the redactor to the catalysts De-NOX reduction section. Now with the catalyst sections (and the DPF section FOR A DIESEL ENGINE) are hot thus fully effective, the main fuel into the engine is injected normally with all pollution abating devices fully and efficiently operational

in the case of a diesel engine the system comprises of a diesel oxidation catalyst (DOC) a diesel particulate filter (DPF) a selective catalyst reduction (SCR) and in parallel to the main exhaust passage of the effluent flue gases (EFG) there is a catalytic hydrogen production section (HPC) which is fed by a mixture of methanol and water which via steam reforming produce hydrogen rich gas which is injected into the SCR for improved De-NOX.

In the invention presented here the injection of urea, or hydrocarbons is avoided as only hydrogen produced on the car by steam reforming of methanol-water mixture is used as reductant.

In the case of an SI engine the invention relates to a system for reducing the emission of hydrocarbons (HC) carbon monoxide (CO) and nitrogen oxides (NOX). Two schemes are possible the first is operating at stochiometric air to fuel ratio and the second in lean burn mode with excess air.

IF the gasoline engine operates at air to fuel close to stochiometric ratio the catalyst installed in the passage of the exhaust gases from the engine is a three way catalyst which oscillates between oxidation and reduction so it oxidizes CO and HC and reduces NOx to N2. the oxidation reduction catalyst is therefore three way catalyst. (TWC.)

Hydrogen could be added as an external reductant into the TWC, for improved De-Nox.

In the case of an SI engine with lean burn mode the catalysts setup in the main passage of exhaust gases an oxidation catalyst followed by a SCR, while in a parallel set up an HPC catalyst is installed for the steam-reforming of a methanol-water mix for producing hydrogen that is injected into the SCR as Reductant for DE-NOx.

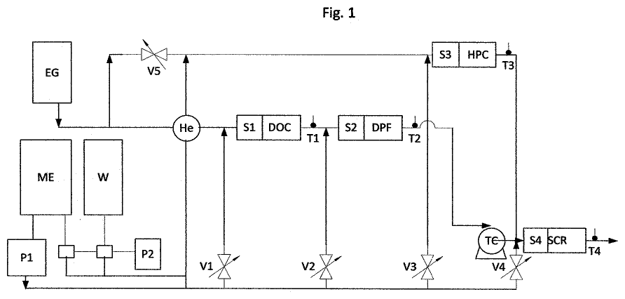

FIG. 1 herewith describes the typical system proposed for a diesel engine: the main exhaust passage way comprises of DOC (diesel oxidation catalyst) located after the HE (heat exchanger) which is located adjacent to the EG from the engine, A TURBOCHARGER for driving an air compressor that compresses air to the engine is optional. DPF (only for diesel engine) and A SCR which contains two parts WHERE the first PART is A reduction catalyst followed by a second part of a mixed oxidation-reduction catalyst.

An HPC catalyst system is installed in parallel to the main exhaust PASSAGE. a mix of methanol and water is pumped through an heat-exchanger where it is heated by the hot flue gases from the engine flue gases EG from the engine.

The hydrogen rich gas is injected upstream of the SCR—the selective reduction catalyst, and serves in reducing the NOx in the first part of reduction catalyst followed by an oxidation-reduction catalyst for polishing the DENOx.

When starting a cold engine the catalysts in the after treatment passageway are largely inactive since they have to attain 300 deg. c. in order to be fully active.

Thus for the first 1-3 minutes from cold startup the catalysts are too cold to be effective and therefore in this initial period of time about 80% of the total emission of pollutants occurs.

Placing the DOC catalyst, (in the case of a lean burn), or the TWC (in the case of stoichiometric burn) too close to the Engine Exhaust will short the catalyst life due its operation too hot at normal operation.

Electrical heating of the catalysts suffers from imposing a too heavy burden on car batteries and heats the catalyst from the outside inward, so the inner part of the catalyst remains cold for too long.

Installing a smaller separate catalyst for startup and switching later to the main one is too complex and insufficient solution for the stringent specs of today and tomorrow.

In the present invention the solution to the cold start problem is to delay the injection of the main fuel and for the first few seconds just use the engine as an air compressor, injecting Methanol into this compressed air and igniting it with an ignitor (metal net) using electric current from the batteries.

Thus, when after a few seconds the catalysts will be sufficiently hot, the Methanol flow into the catalysts will be cut off and then the main fuel, Diesel or Gasoline, will be injected into the engine and the exhaust gas will pass through the already hot catalysts,

Another acute problem in pollution abatement is the removal of NOx from the exhaust gases.

NOx are produced in the hot engine from reaction between Nitrogen and Oxygen at very high temperatures. In a typical Diesel Engine a portion of the NOx reacts with the HC and CO in the DOC converting them to carbon dioxide and water via being reduced to nitrogen.

In a typical gasoline engine this is done in the TWC operating in stoichiometric conditions.

A big portion of the NOx however, still remains unconverted after the DOC or the TWC and a second catalyst, SCR, (SELECTIVE CATALYST REDUCTION) is required for DE-NOx.

There is extensive use of Urea as a reductant of NOx.

However Urea is smelly and not efficient enough for DE-NOx. Furthermore a slip of urea exits at the exhaust.

In the present Invention a mixture of Methanol and Water in exact proportions is heated via heat exchange by the hottest exhaust gases leaving the engine, and the mixture is then injected into the HPC catalyst where it catalytically reacts to produce a rich Hydrogen stream which is injected into the SCR. Thus in this invention rich hydrogen stream is produced as needed

### DETAILED DESCRIPTION OF THE DRAWINGS

FIG. 1 is a general flow scheme for Diesel oil engine with an exhaust after treatment system with oxidation catalyst (DOC) and selective reduction catalyst (SCR)

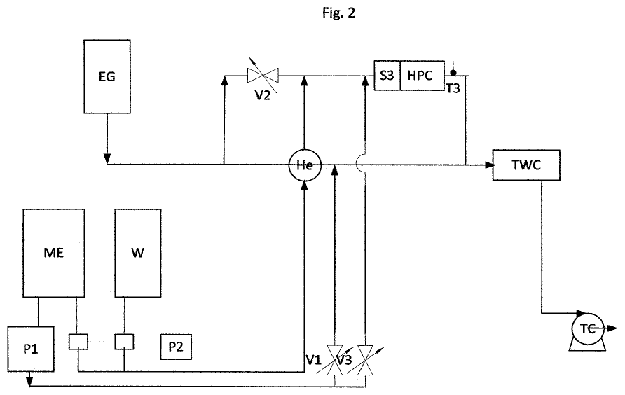

FIG. 2 is a general flow scheme for Gasoline (or CNG or LPG) engine with an exhaust after treatment system with Three Way Catalyst (TWC)

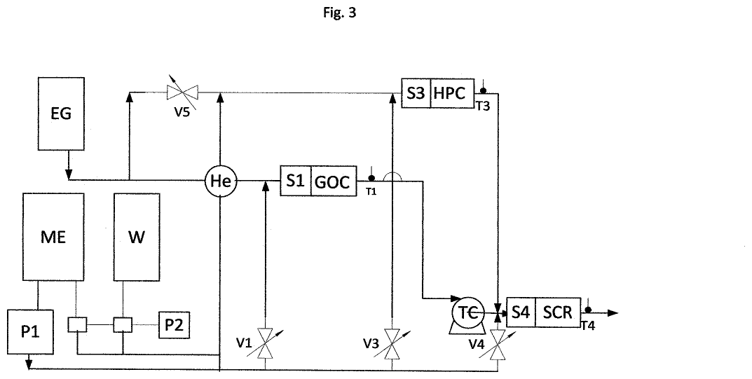

FIG. 3 is a general flow scheme for gasoline (or CNG or LPG) engine with an exhaust after treatment system with oxidation catalyst (GOC) and selective reduction catalyst (SCR)

### AGENDA

EG: engine exhaust
ME: methanol tank
W: water tank
HE: heat exchanger device to heat methanol-water mix en route to the HPC
V: solenoid valve, on/off position receiving signals from car computer
S: ignitor of methanol air mix. Heated by car batteries. Controlled by signals from car computer.
TC: Turbo-Charger
P1: Methanol Pump
P2: Two Head pump for methanol and water
DOC: Diesel Oxidation Catalyst
DPF: Diesel Particulate Filter
HPC: Hydrogen Production Catalyst
SCR: Selective Catalyst Reduction
TWC: Three WAY Catalyst
GOC: Gasoline Oxidation Catalyst.

### DETAILED DESCRIPTION RELATING TO DIESEL ENGINE (FIG. 1)

When starting the engine from cold the engine will commence operation by compressing air but the main fuel injection will be delayed until all thermometers T1, T2. T3 AND T4 indicate that the required temperatures are high enough for the efficient operation of the various catalysts.

At cold start up the temperature sensor T1 starts the methanol pump P1 while at same instant opens valve V1 to pass methanol to the DOC and closes s1 breaker to pass electric current from the batteries to the metal wire net located at the inlet of DOC and serves as ignitor.

The methanol which mixes with the compressed air from the engine cylinders is ignited and while being combusted, a non flame combustion, in the DOC, heats the DOC catalyst up to a predetermined temperature, which is higher than the minimum temperature required for the DOC catalyst to function properly, usually above 300 deg. c.

When T1 measures that the predetermined temperature needed for efficient catalyst activity is attained T1 emits a signal that opens V2, activates S2 and simultaneously shuts valve V1 and the electric current to S1.

The methanol now flows into the after treatment passage and mixes with the compressed air from the engine cylinders through the ignitor metal ring S2 mounted at the mouth of DPF section where it is ignited, heating the DPF up to the predetermined required temperature for the proper operation of the DPF as measured by T2

Thermometer T2 will open valve V4 and activate S4, the metal net ignitor, that upon heating will start the combustion of the injected methanol until catalyst SCR is heated up to the predetermined temperature required for the adequate operation of the catalyst in sections SCR, then the signal from T4 mounted at the outlet of the SCR section will shut off valve V4 and cut the electric current to the ignitor heated metal ring S4

In parallel to the preheating of the catalysts in the main passage the HPC section is also heated. thermometer T3, mounted at the outlet of the HPC catalyst, will now open valves V3 and V5 and the electric current for S3. The methanol injected through valve v3 mixed with the air from valve V5 ignited by S3 will ignite the methanol-air mixture and the heat of combustion of the methanol injected heats catalyst HPC up to the predetermined temperature.

Now that all four sections: DOC, DPF. SCR, HPC, are all hot and the temperatures sensors T1, T2, T3, T4, indicate that the predetermined temperatures for all the above catalysts and filter were attained VALVES v1, v2, v3, v4, v5, now close, pump P1 shuts down and electric breakers of ring nets S1, S2, S3, S4, open the engine is now ready to commence normal operation, with all the hot catalysts and the DPF properly functioning.

A mixture of methanol-water is now injected by the two heads pump P2 and the mix is heated by the exhaust gases from the engine via HE, located adjacent to the engine, and the hot mix is now injected into the HPC catalyst section which is now at the proper temperature for the steam-reforming of methanol for production of Hydrogen rich gas which flows into the SCR section.

The DIESEL OIL is now injected into the ENGINE which now operates normally, under load, with all the catalysts DOC, SCR, HPC, and the DPF are now hot, active and fully functional.

### DETAILED DESCRIPTION FOR A SI SPARK-IGNITION ENGINE: FOR GASOLINE, CNG, OR LPG. WITH A TWC CATALYST. (FIG. 2)

At cold start the engine starts to operate, compressing air into the exhaust after treatment passage while injection of the main fuel, gasoline or gas, is delayed as long as T1, measuring the outlet temperature from the TWC catalyst and T2, measuring the outlet temperature from the HPC catalyst are below the predetermined temperatures required for proper functioning of the catalysts, in a similar way as explained in FIG. 1 above.

When either T1 or T2 is below the necessary temperature required for adequate operation of either of the two catalysts, valves V1. V2 and V3 open and electric current from the car batteries is flowing to the metal Ignition rings located at the inlet to each of the two catalysts: S1 for the HPC catalyst and S2 for the TWC catalyst

The combustion of the Methanol-Air mixture, under catalytic conditions, heats both catalysts: TWC (three way catalyst) and HPC (hydrogen production catalyst). Preferably, for better control the heating of the TWC and HPC sections nay be done in sequence

When both catalysts attain the desired temperatures then valves V1 and V2 shut-off and the power supply to the ignition rings at each of the catalyst sections S1 and S2 is cut off. and pump P1 is shut off.

At that instant valve pump P2 cuts in and the mixture of methanol and water that flows into the HPC catalyst is producing hydrogen which is injected into the SCR catalyst.

The main fuel, Gasoline (or LPG or CNG) in now cut in into the engine and normal operation commences.

### DETAILED DESCRIPTION FOR A SI SPARK IGNITION ENGINE FOR GASOLINE, CNG OR LPG WITH LEAN BURN (FIG. 3)

This scheme is very similar to that of a Diesel-engine (see FIG. 3) except that the DPF for a SI spark engine is not required. Thus referring to FIG. 1 here DPF valve V2 and thermometer T2 are not necessary.

Other than that the system is identical to that of diesel engine and the cold start up and the hydrogen reduction of NO x procedures are the same as in FIG. 1

1. A system and apparatus for the improved cold startup and DE-NOx of an Internal Combustion Engine where, upon pushing the startup button, when the engine and the after treatment system are cold the engine will, for a few seconds compress air while delaying the injection of the main fuel into the engine; at the same time auxiliary fuel is injected into the catalyst or the DPF section in the case of diesel engine in sequence and the mixture of auxiliary fuel-air mixture, is ignited by a metal net connected to an electric source such as batteries.

2. The system according to claim 1, wherein the auxiliary fuel is alcohol.

3. The system according to claim 2, wherein the alcohol is Methanol.

4. The system according to claim 1, wherein each of the catalysts is equipped with a metal net at the inlet of each catalyst or DPF, which is connected to an electric power source, which is heated electrically thus igniting the auxiliary methanol-air mixture.

5. The system according to claim 4, wherein the electric power source is an electric battery such as a car battery.

6. The system according to claim 1, wherein each of the catalyst sections is equipped with a thermometer mounted at the outlet of each catalyst or the DPF in the case of a diesel engine

7. The system according to claim 1, wherein at the cold startup each catalyst or the DPF in the case of a diesel engine, is heated by the combustion of the Methanol with the compressed air from the engine operating on electric power from the batteries, before the main fuel is injected.

8. The system according to claim 1, wherein the signal from the thermometer mounted at the outlet of each section controls the methanol to each section: opening the methanol valve to the section at low temperature while closing the electric breaker to the metal ring ignitor of this section and closes the methanol valve and opens the breaker to the ignitor when this thermometer indicates that the predetermined temperature required for an adequate operation of the section is attained.

9. The system according to claim 1, wherein the sequence of heating of the various sections in the after treatment passage of the exhaust gases is from the engine flue gas outlet in sequence to the exit tail pipe.

10. The system according to claim 1, wherein parallel to the main passage a catalytic section is mounted for steam reforming of a methanol-water mix for the production of a rich hydrogen gas stream (HPC catalyst) to be injected into the SCR catalytic section (De-NOX).

11. The system according to claim 10, wherein the catalytic section (HPC) is preheated by a mix of methanol and air from the compressed air from the engine that flow to the parallel section of the steam reforming HPC prior to the injection of the main fuel into the engine.

12. The system according to claim 11, wherein the above HPC is preceded by an ignitor metal net connected to a power supply which in the case of a vehicle engine is the vehicle battery.

13. The system according to claim 12, wherein the HPC catalyst is heated by the mix of auxiliary fuel and air up to a predetermined temperature required for an adequate operation of the HPC catalyst.

14. The system according to claim 13, wherein at HPC normal operation the passage of the engine gases to the HPC catalyst is cut off and a mix of methanol and water flow, via being heated by the heat exchanger (HE) with the flue gases from the engine to a temperature needed for the steam reforming to produce a rich hydrogen gas stream in the HPC catalyst which is injected into the SCR (De-Nox) section.

15. The system according to claim 1, wherein when all the temperatures of the catalysts are at the required temperatures for the catalysts to be effective and the HPC is producing rich hydrogen stream the main fuel is injected into the engine and the engine then operates normally under load.

16. The system according to claim 1, wherein the metals on the catalysts of the oxidation section, the TWC section and the SCR (De-NOx) section are PGM metals specifically: Platinum, Palladium and Rhodium and on the SCR catalysts also other metals.

17. The system according to claim 14, wherein the catalytic HPC section for the production of hydrogen is by steam reforming of water and methanol.

18. The system according to claim 17, wherein the HPC catalyst is preferably based on copper-zinc Oxides.

19. The system according to claim 17, wherein the HPC catalyst operates preferably at 3 atm. and at a temperature in the range of 200-300 degrees Celsius.

20. The system according to claim 17, wherein the preferred ratio of water to methanol is 1.6.

21. The system according to claim 1, wherein the DPF in the case of a diesel engine is regenerated periodically by injection of methanol into the DPF section and using the excess air in the flue gases ignite the Methanol by the electric ignitor net installed at the inlet to the DPF section.

22. The system according to claim 1, wherein the setup of cold start is automatically activated after the catalysts are cooled due to stops at red lights or traffic jams and T1, or T2 or T3 or T4 indicate that the temperature of the catalyst section they measure is too low; then Methanol would be injected to this very section together with the net ring at the inlet of this section will ignite the Methanol injected which will burn until the thermometer at the outlet of the catalyst indicate that the required temperature needed for the effective performance of the catalyst is attained and the injection of the main fuel into the engine could be resumed.
